(19) United States
(12) Patent Application Publication
(10) Pub. No.: US 2025/0070226 A1
(43) Pub. Date: Feb. 27, 2025

(54) IONIC LIQUID, ELECTROLYTE INCLUDING THE SAME, AND LITHIUM SECONDARY BATTERY INCLUDING THE SAME

(71) Applicants: Hyundai Motor Company, Seoul (KR); Kia Corporation, Seoul (KR)

(72) Inventors: Kyu Ju Kwak, Hwaseong (KR); Ji Yong Lee, Seongnam (KR); Won Keun Kim, Seoul (KR); Eun Ji Kwon, Yongin (KR); Yeon Jong Oh, Seoul (KR); Ji Ho Lim, Seoul (KR); Dong Hyun Lee, Seoul (KR); Sang Su Lee, Suwon (KR); Kyoung Han Ryu, Yongin (KR); Samuel Seo, Suwon, Gyeonggi-do (KR)

(21) Appl. No.: 18/609,505

(22) Filed: Mar. 19, 2024

(30) Foreign Application Priority Data
Aug. 21, 2023 (KR) 10-2023-0108784

(51) Int. Cl. H01M 10/052; H01M 10/0567; H01M 10/0568

(52) U.S. Cl. CPC H01M 10/052; H01M 10/0567; H01M 10/0568; H01M 2300/0025

(57) ABSTRACT

Disclosed are an ionic liquid, an electrolyte including the ionic liquid, and a lithium secondary battery including the same. The ionic liquid is capable of forming a film having high ionic conductivity on an anode upon reductive decomposition of cations contained therein, and delaying the decomposition of anions.

### CROSS-REFERENCE TO RELATED APPLICATION

This application claims, under 35 U.S.C. § 119(a), the benefit of Korean Patent Application No. 10-2023-0108784, filed on Aug. 21, 2023, the entire contents of which are incorporated herein by reference.

### BACKGROUND

### Technical Field

The present disclosure relates to an ionic liquid, an electrolyte including the ionic liquid, and a lithium secondary battery including the same, in which the ionic liquid is capable of forming a film having high ionic conductivity on an anode upon reductive decomposition of cations contained therein, and delaying decomposition of anions.

### Background

Lithium secondary batteries have recently gained increasing importance as a power source for electric vehicles and as a renewable energy power storage device. Lithium secondary batteries currently produced and sold are manufactured using carbon for the anode, a transition metal oxide for the cathode, and an organic electrolytic solution for the electrolyte. Due to high energy density and long lifespan thereof, such lithium secondary batteries have now become the mainstay of secondary batteries, surpassing nickel-cadmium batteries and nickel-hydrogen batteries that were developed earlier.

Attempts to apply various organic electrolytic solutions have continued to improve the performance and stability of lithium secondary batteries, and recently, technology for applying ionic liquids with high thermal stability, non-volatility, and non-flammability has been studied. Ionic liquids are composed of organic cations with low structural symmetry and anions. The ionic liquids are liquid in a wide temperature range, have low vapor pressure, are flame retardant, have excellent heat resistance, are chemically stable, and have high polarity and ionic conductivity.

Conventionally, PYR_{12O1}⁺ cations and FSI⁻ (fluorosulfonyl imide) anions have been used for ionic liquids. However, when the ionic liquid is exposed to an anode, the LUMO (lowest unoccupied molecular orbital) energy level is low, easily causing reductive decomposition of cations and forming a high-resistance film on the surface of the anode, which is undesirable.

Meanwhile, in addition to commonly used ether- and carbonate-based organic electrolytic solutions, there are attempts to use N,N-dimethylsulfamoyl fluoride (hereinafter referred to as DMSF).

The DMSF-based electrolyte is decomposed at the anode to form a film that limits direct contact between the electrolytic solution and the anode surface, delaying further decomposition of the electrolytic solution. As such, the film has the advantage of preventing performance deterioration due to high ionic conductivity thereof. Moreover, the DMSF-based electrolyte weakly binds to lithium ions when lithium salt is dissolved in the DMSF electrolyte, inducing rapid intercalation and deintercalation of lithium, thereby suppressing lithium side reactions and dendrite growth.

However, the DMSF-based electrolyte weakly binds to the anions contained in the lithium salt when the lithium salt is dissolved, thereby accelerating oxidative decomposition of the anions, and upon repeated charging and discharging of a lithium secondary battery including the DMSF-based electrolyte, performance may deteriorate due to oxidative decomposition of the anions.

### SUMMARY OF THE DISCLOSURE

The present disclosure has been made keeping in mind the problems with the ionic liquid and DMSF-based electrolyte encountered in the related art, and is intended to provide an ionic liquid capable of forming a film having high ionic conductivity on the surface of an anode during a charging process.

In addition, the present disclosure is intended to provide an ionic liquid with improved oxidation stability by delaying oxidative decomposition of anions observed in conventional DMSF-based electrolytes.

In particular, by converting DMSF into an ionic liquid and using the same as an organic solvent or additive for electrolytes, the characteristics of ionic liquids, such as high thermal stability, non-volatility, and non-flammability, and the characteristics of DMSF such as formation of a film having high ionic conductivity may be simultaneously realized.

The objects of the present disclosure are not limited to the foregoing. The objects of the present disclosure will be able to be clearly understood through the following description and to be realized by the means described in the claims and combinations thereof.

An aspect of the present disclosure provides an ionic liquid for a lithium secondary battery, including a cation represented by Chemical Formula 1 below and an anion:

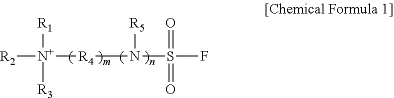

in the Chemical Formula 1, n is 0 or 1, m is 0 or 1,
each of R₁, R₂, R₃ and R₅ is selected from the group consisting of alkyl, cycloalkyl, trifluoromethyl, alkyl ether, cycloalkyl ether, sulfamoyl fluoride, sulfonyl fluoride, alkyl sulfonyl fluoride, halide, alkyl fluoride, cycloalkyl fluoride, alkyl chloride, cycloalkyl chloride, alkyl bromide, and cycloalkyl bromide, and
R₄ is selected from the group consisting of alkyl, cycloalkyl, alkyl ether, and cycloalkyl ether.

In an exemplary embodiment, two of R₁, R₂, R₃ may be connected to each other to form an alicyclic hydrocarbon ring, and the alicyclic hydrocarbon ring may have 3 to 5 carbon atoms.

In an exemplary embodiment, the anion portion may include at least one selected from the group consisting of N(SO₂F)₂⁻, FSI⁻, CF₃SO₃⁻, N(SO₂CF₃)₂⁻, N(COCF₃)(SO₂CF₃)⁻, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, N(CN)₂⁻, C(CN)₃⁻, SCN⁻, SeCN⁻, CuCl₂⁻, AlCl₄⁻, F(HF)_{2.3}, Cl⁻, F⁻, Br⁻, I⁻, and combinations thereof.

In an exemplary embodiment, the LUMO (lowest unoccupied molecular orbital) energy level of the ionic liquid(LUMO_{IL}) may be similar to the LUMO energy level of DMSF (N,N-dimethylsulfamoyl fluoride)(LUMO_{DMSF}).

Specifically, the ratio (LUMO_{IL}/LUMO_{DMSF}) of the LUMO energy level of the ionic liquid(LUMO_{IL}) to the LUMO energy level of DMSF(LUMO_{DMSF}) may be about 0.85-1.15.

The absolute value (|LUMO_{IL}−LUMO_{DMSF}|) of a difference between the LUMO energy level of the ionic liquid(LUMO_{IL}) and the LUMO energy level of DMSF(LUMO_{DMSF}) may be 5 eV or less.

In an exemplary embodiment, the LUMO energy level of the ionic liquid(LUMO_{IL}) may be greater than the LUMO energy level of a conventional ionic liquid(LUMO_{COV}). Specifically, the ratio (LUMO_{IL}/LUMO_{COV}) of the LUMO energy level of the ionic liquid(LUMO_{IL}) to the LUMO energy level of the conventional ionic liquid(LUMO_{COV}) may be about 1.4 or less but greater than about 1.0.

In an exemplary embodiment, the HOMO (highest occupied molecular orbital) energy level of the ionic liquid(HOMO_{IL}) may have a negative value greater than the HOMO energy level of DMSF(HOMO_{DMSF}).

Another aspect of the present disclosure provides an electrolyte for a lithium secondary battery, including the ionic liquid described above and a lithium salt.

In an exemplary embodiment, the lithium salt may include at least one selected from the group consisting of LiFSI, LiTFSI, LiPF₆, LiClO₄, LiBF₄, LiSO₃CF₃, LiBOB, LiFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, and combinations thereof.

In an exemplary embodiment, the electrolyte may further include an organic solvent.

In an exemplary embodiment, the electrolyte may include no additional additive.

Still another aspect of the present disclosure provides a lithium secondary battery, including a cathode, an anode, a separator interposed between the cathode and the anode, and optionally, the electrolyte with which at least one of the cathode, the anode, or the separator is impregnated.

In an exemplary embodiment, the anode may include a film located on at least a portion of the surface thereof, the film may be formed by reductive decomposition of the cationic portion, and the film may include at least one selected from the group consisting of S⁻, S²⁻, and combinations thereof.

In an exemplary embodiment, based on a result of X-ray photoelectron spectroscopy (XPS) of the film, an S 2p peak may appear at a binding energy of about 158 eV to about 165 eV.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1A shows a cross-sectional view of a lithium secondary battery according to the present disclosure;

FIG. 1B shows a cross-sectional view of a lithium secondary battery including a film formed on the anode by charging the lithium secondary battery according to FIG. 1A;

FIG. 2 shows results of measurement of current for a secondary battery using a lithium salt at different concentrations and a conventional ionic liquid as an electrolyte;

FIG. 3A shows results of calculation of the HOMO (highest occupied molecular orbital) distribution using density functional theory (DFT) for the electrolyte of FIG. 2;

FIG. 3B shows results of calculation of the LUMO (lowest unoccupied molecular orbital) distribution using DFT for the electrolyte of FIG. 2;

FIG. 4A shows O 1s XPS results for an electrolyte including a conventional ionic liquid;

FIG. 4B shows O 1s XPS results measured after exposing the electrolyte including the conventional ionic liquid to an anode;

FIG. 5 shows the HOMO and LUMO energy levels for Examples and Comparative Examples;

FIG. 6A shows results of calculation of the HOMO distribution using DFT for Example 1;

FIG. 6B shows results of calculation of the LUMO distribution using DFT for Example 1;

FIG. 7 shows results of calculation of the LUMO distribution using DFT for Example 2;

FIG. 8 shows results of calculation of the LUMO distribution using DFT for Example 3;

FIG. 9A shows ¹H-NMR measurement results for Example 2; and

FIG. 9B shows ¹⁷F-NMR measurement results for Example 2.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

Lithium metal is highly reactive and thus causes reductive decomposition of an electrolyte when coming into contact with the electrolyte, thereby forming a film (a solid electrolyte interface (SEI) layer) on the surface of lithium metal. Here, in the case in which the film is formed unevenly, the supply of lithium ions becomes unstable and lithium dendrites grow on the surface of lithium metal.

Also, non-uniform intercalation of lithium ions continuously causes side reactions between lithium metal and the electrolyte, which not only thickens the film but also causes depletion of the electrolyte.

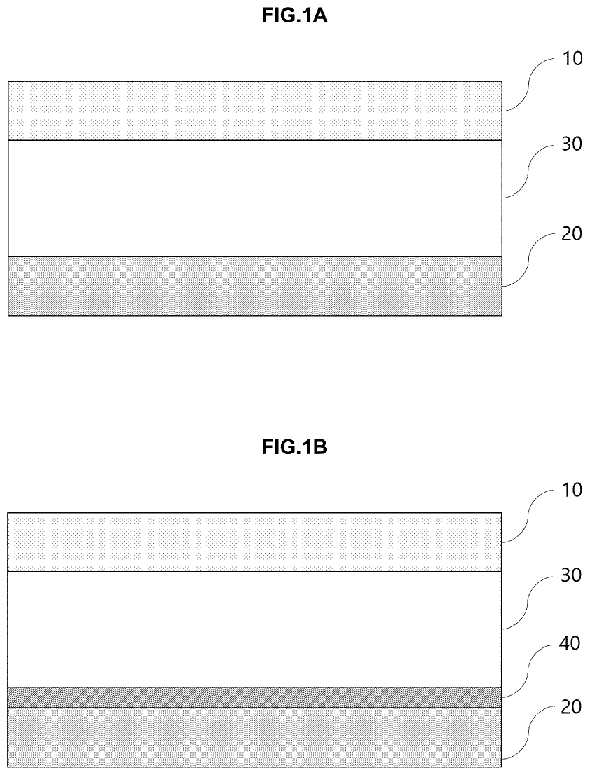

FIG. 1A is a cross-sectional view showing a lithium secondary battery according to the present disclosure. Referring thereto, the lithium secondary battery may include a cathode 10, an anode 20, and a separator 30 interposed between the cathode 10 and the anode 20. The lithium secondary battery may be impregnated with an electrolyte (not shown).

FIG. 1B is a cross-sectional view showing a lithium secondary battery including a film 40 formed on the anode 20 by charging the lithium secondary battery according to FIG. 1A.

Referring to FIG. 1B, the lithium secondary battery may include a film 40 (a solid electrolyte interface layer, SEI layer) located on the anode 20.

The cathode 10 may include a cathode active material, a binder, and a conductive material, or the like.

The cathode active material may include at least one selected from the group consisting of LiCo₂, LiNiCoMnO₂, LiNiCoAlO₂, LiMn₂O₄, LiFeO₄, and combinations thereof. However, the type of cathode active material is not limited thereto and may further include any type commonly used in the art to which the present disclosure belongs.

The binder serves to attach particles of the cathode active material. Examples of the binder may include, but are not limited to, polyvinyl alcohol, carboxymethylcellulose, hydroxypropylcellulose, diacetylcellulose, polyvinyl chloride, carboxylated polyvinyl chloride, polyvinyl fluoride, polymers including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, and the like.

The conductive material serves to impart conductivity to the cathode active material. The conductive material may include any material that may conduct electrons without causing chemical changes in the battery. Examples thereof may include graphite such as natural graphite or artificial graphite; carbon-based materials such as carbon black, acetylene black, Ketjen black, channel black, furnace black, lamp black, and summer black; conductive fiber such as carbon fiber or metal fiber; metal powder such as carbon fluoride, aluminum, or nickel powder; conductive whisker such as zinc oxide or potassium titanate; conductive metal oxide such as titanium oxide; conductive materials such as polyphenylene derivatives, and the like.

The anode 20 may include lithium metal or a lithium metal alloy.

The lithium metal alloy may include an alloy of lithium and a metal or metalloid capable of alloying with lithium. The metal or metalloid capable of alloying with lithium may include at least one selected from the group consisting of Li, Na, K, Rb, Cs, Fr, Be, Mg, Ca, Sr, Si, Sb, Pb, In, Zn, Ba, Ra, Ge, Al, Sn, and combinations thereof.

The lithium metal has high electrical capacity per unit weight, which may be advantageous for the formation of high-capacity batteries.

The separator 30 serves to prevent contact between the cathode 10 and the anode 20. The separator 30 is not limited, so long as it is commonly used in the art to which the present disclosure belongs, and may be, for example, made of a polyolefin material such as polypropylene (PP) or polyethylene (PE).

The electrolyte according to the present disclosure may include an ionic liquid and a lithium salt, and may further include an organic solvent and/or an additive. The lithium salt may include all types of lithium salts that may be used in electrolytes when manufacturing typical lithium secondary batteries.

For example, the lithium salt may include at least one selected from the group consisting of LiFSI, LiTFSI, LiPF₆, LiClO₄, LiBF₄, LiSO₃CF₃, LiBOB, LiFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, and combinations thereof. Preferably, the lithium salt is LiFSI.

The organic solvent may include all types of organic solvents and mixed compositions thereof that may be used in electrolytes when manufacturing typical lithium secondary batteries. For example, the organic solvent may include N,N-dimethylsulfamoyl fluoride (DMSF).

The additive is decomposed prior to the organic solvent, thereby forming the film 40 on the surface of the anode 20. The additive may include all types of additives that may be used in electrolytes when manufacturing typical lithium secondary batteries. Examples of the additive may include VC (vinylene carbonate), FEC (fluoroethylene carbonate), TTE (1,1,2,2-tetrafluoroethyl-2,2,3,3-tetrafluoropropyl ether), and the like.

The ionic liquid is composed of a cationic portion with low structural symmetry and an anionic portion, and a “conventional ionic liquid” may be an ionic liquid that does not contain —SO₂F in the cationic portion. Specifically, the conventional ionic liquid containing PYR_{12O1}⁺ (N-methoxyethyl-N-methylpyrrolidinium) cation and FSI⁻ (fluorosulfonyl Imide) anion is disclosed. When a lithium secondary battery is manufactured using an electrolyte including the conventional ionic liquid [PYR_{12O1}⁺][FSI⁻] and then charged, the conventional ionic liquid may be decomposed and a high-resistance film 40 may be formed on the surface of the anode 20 of the secondary battery.

Specifically, the conventional ionic liquid is decomposed through oxidation and reduction, in which oxidation occurs mainly in the anionic portion, FSI⁻, and reduction mainly occurs in the cationic portion, PYR_{12O1}⁺. Here, the film 40 formed on the surface of the anode 20 may result from decomposition of the cationic portion of [PYR_{12O1}⁺][FSI⁻].

This result is based on the general understanding that, among cations and anions, cations, which have lower electron density, are more likely to receive electrons than anions.

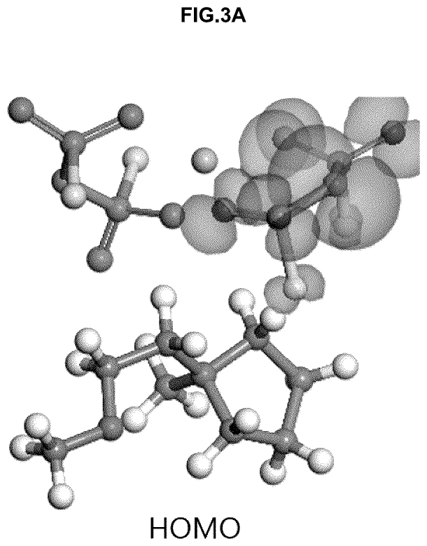

Meanwhile, S 2p XPS results for the film 40 formed on the surface of the anode 20 by charging a lithium secondary battery manufactured using an electrolyte including conventional DMSF as an organic solvent have been reported (Energy Environ. Sci. 2020, 13, 212-220, FIG. 3d). Accordingly, S⁻ (LiS) and S²⁻ (Li₂S) peaks were observed at about 158 eV to 165 eV.

Thereby, it can be confirmed that a film 40 including LiS or Li₂S is formed on the surface of the anode 20 when an electrolyte including DMSF is used. The film 40 including LiS or Li₂S is known to have higher ionic conductivity than the ROLi film 40.

The present disclosure is intended to solve the problem of forming a high-resistance film 40 when the conventional ionic liquid is used as an electrolyte as described above and also to provide an ionic liquid with high thermal stability, non-volatility, and non-flammability as when using a conventional ionic liquid as an electrolyte. Specifically, in the present disclosure, DMSF, which was conventionally used as an organic solvent in electrolytes, is provided as an ionic liquid with a new structure including a cationic portion represented by Chemical Formula 1 below and an anionic portion. Hereinafter, the ionic liquid with the new structure is defined as ionic-liquified DMSF.

An aspect of the present disclosure may provide an ionic liquid including a cationic portion represented by Chemical Formula 1 below and an anion portion.

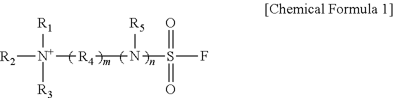

In Chemical Formula 1, n is 0 or 1, m is 0 or 1, each of R₁ to R₃ and R₅ is selected from the group consisting alkyl, cycloalkyl, trifluoromethyl, alkyl ether, cycloalkyl ether, sulfamoyl fluoride, sulfonyl fluoride, alkyl sulfonyl fluoride, halide, alkyl fluoride, cycloalkyl fluoride, alkyl chloride, cycloalkyl chloride, alkyl bromide, and cycloalkyl bromide, and R₄ is selected from the group consisting of alkyl, cycloalkyl, alkyl ether, and cycloalkyl ether. Here, in R₁ to R₃ and R₅, alkyl has 1 to 10 carbon atoms, cycloalkyl has 3 to 6 carbon atoms, alkyl ether has 2 to 11 carbon atoms, and cycloalkyl ether has 3 to 6 carbon atoms.

Also, in R₄, alkyl has 1 to 10 carbon atoms, cycloalkyl has 3 to 6 carbon atoms, alkyl ether has 2 to 11 carbon atoms, and cycloalkyl ether has 3 to 6 carbon atoms.

Also, adjacent two of R₁ to R₃ may be connected to each other to form an alicyclic hydrocarbon ring, and the alicyclic hydrocarbon ring may have 3 to 5 carbon atoms.

Specifically, R₁ and R₂ may be connected to form a ring, R₂ and R₃ may be connected to form a ring, or R₃ and R₁ may be connected to form a ring.

Specifically, the cationic portion represented by Chemical Formula 1 may include the following formulas 1 to 12. Here, the scope of Chemical Formula 1 of the present disclosure is not limited thereto.

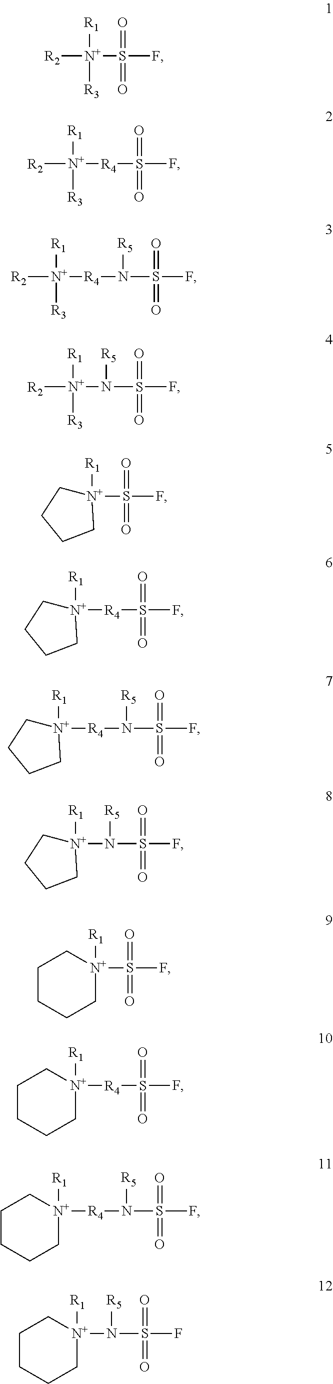

In the above formulas 1 to 12, R₁, R₂, R₃, R₄, and R₅ are as described above.

Referring to the Chemical Formula 1, the cationic portion essentially includes N⁺ and —SO₂F groups. Accordingly, the ionic liquid including the cationic portion may be obtained by converting DMSF ((CH₃)₂NSO₂F) into an ionic liquid. Since the ionic liquid according to the present disclosure is ionic-liquified DMSF, both formation of a film 40 having high ionic conductivity such as LiS or Li₂S when using the conventional DMSF as an electrolyte and high thermal stability, non-volatility, and non-flammability when using the conventional [PYR_{12O1}⁺][FSI⁻] as an ionic liquid may be achieved simultaneously.

In addition, when ionic-liquified DMSF is used, the electrons in the anionic portion that strongly bind to the cationic portion are delocalized, making it difficult to lose electrons, and thus, oxidation stability may be increased.

In an exemplary embodiment, the anionic portion may include at least one selected from the group consisting of N(SO₂F)₂⁻, FSI⁻, CF₃SO₃⁻, N(SO₂CF₃)₂⁻, N(COCF₃)(SO₂CF₃)⁻, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, N(CN)₂⁻, C(CN)₃⁻, SCN⁻, SeCN⁻, CuCl₂⁻, AlCl₄⁻, F(HF)_{2.3, Cl}⁻, F⁻, Br⁻, I⁻, and combinations thereof. In addition thereto, the anionic portion may further include the same anion as in the lithium salt.

Meanwhile, HOMO (highest occupied molecular orbital) energy level is the molecular orbital with the highest energy in which electrons may participate in bonding, and LUMO (lowest unoccupied molecular orbital) energy level is the molecular orbital with the lowest energy level in the non-binding region of electrons. When the HOMO energy level is high, oxidation may become easy by losing electrons, and when the LUMO energy level is low, reduction may become easy by gaining electrons.

In regard thereto, the LUMO energy level of the ionic liquid(LUMO_{IL}) and the LUMO energy level of DMSF (N,N-dimethylsulfamoyl fluoride) (LUMO_{DMSF}) may be similar to each other. Also, the LUMO energy level of the ionic liquid may be higher than the LUMO energy level of the conventional ionic liquid.

Specifically, the ratio (LUMO_{IL}/LUMO_{DMSF}) of the LUMO energy level of the ionic liquid(LUMO_{IL}) to the LUMO energy level of DMSF(LUMO_{DMSF}) may be 0.85-1.15.

Alternatively, the absolute value (|LUMO_{IL}-LUMO_{DMSF}|) of the difference between the LUMO energy level of the ionic liquid(LUMO_{IL}) and the LUMO energy level of DMSF(LUMO_{DMSF}) may be 5 eV or less.

Also, the LUMO energy level (LUMO_{IL}) of the ionic liquid may be greater than the LUMO energy level (LUMO_{COV}) of the conventional ionic liquid. Specifically, the ratio (LUMO_{IL}/LUMO_{COV}) of the LUMO energy level (LUMO_{IL}) of the ionic liquid to the LUMO energy level (LUMO_{COV}) of the conventional ionic liquid may be greater than 1.0. The upper limit of the ratio of LUMO energy levels (LUMO_{IL}/LUMO_{COV}) is not particularly limited, but may be, for example, 3.0 or less but greater than 1.0, 2.0 or less but greater than 1.0, preferably 1.4 or less but greater than 1.0. Here, the “LUMO energy level of a conventional ionic liquid(LUMO_{COV})” may mean the LUMO energy level of an ionic liquid that does not contain —SO₂F in the cation portion. For example, the LUMO energy level of the conventional ionic liquid(LUMO_{COV}) may mean the energy level of [PYR_{12O1}⁺][FSI⁻].

As such, the LUMO energy level of the ionic liquid(LUMO_{L}) is higher than the LUMO energy level of the conventional ionic liquid(LUMO_{COV}) and is similar to the LUMO energy level of DMSF(LUMO_{DMSF}), so reductive decomposition of the cationic portion may be delayed compared to when using the conventional ionic liquid, and at the same time, the composition and thickness of the film 40 formed on the surface of the anode 20 by reductive decomposition may be similar to those of conventional DMSF.

In an exemplary embodiment, the HOMO energy level of the ionic liquid(HOMO_{IL}) may be lower than the HOMO energy level of DMSF (N,N-dimethylsulfamoyl fluoride)(HOMO_{DMSF}). Specifically, the HOMO energy level of the ionic liquid(HOMO_{IL}) may have a negative value greater than the HOMO energy level of DMSF(HOMO_{DMSF}).

As such, since the HOMO energy level of the ionic liquid(HOMO_{IL}) is lower than the HOMO energy level of DMSF(HOMO_{DMSF}), oxidative decomposition of the anion portion may be delayed compared to when DMSF is used as an electrolyte.

In an exemplary embodiment, the anode 20 may include the film 40 formed as a result of charge/discharge cycles, the film 40 may be formed by reductive decomposition of the cationic portion, and the film 40 may include at least one selected from the group consisting of S⁻, S²⁻, and combinations thereof. Also, based on results of X-ray photoelectron spectroscopy (XPS) of the film 40, the S 2p peak may appear at a binding energy of 158 eV to 165 eV.

The ionic liquid according to the present disclosure contains a —SO₂F group in the cation portion. During charging and discharging of a lithium secondary battery manufactured using an electrolyte including the ionic liquid, the cationic portion may undergo reductive decomposition to form a film 40 including LiS or Li₂S on the surface of the anode 20. In this way, according to the present disclosure, it is possible to form a film 40 having higher ionic conductivity than LiOR formed in the process of using the conventional ionic liquid.

Meanwhile, the ionic liquid according to the present disclosure may be included in various amounts in the electrolyte. When a small amount of the ionic liquid is included in the electrolyte, it may act as an additive. Here, the electrolyte may further include an organic solvent. When an appropriate amount of the ionic liquid is included in the electrolyte, it may be mixed with a conventional DMSF organic solvent. Also, when a large amount of the ionic liquid is included in the electrolyte, the electrolyte may be composed of the ionic liquid alone without a separate DMSF organic solvent.

A better understanding of the present disclosure may be obtained through the following examples and comparative examples. However, these examples are not construed as limiting the scope of the present disclosure.

### Example 1

An ionic liquid including a cationic portion represented by the following chemical formula and an FSI anionic portion was designed.

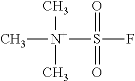

### Example 2

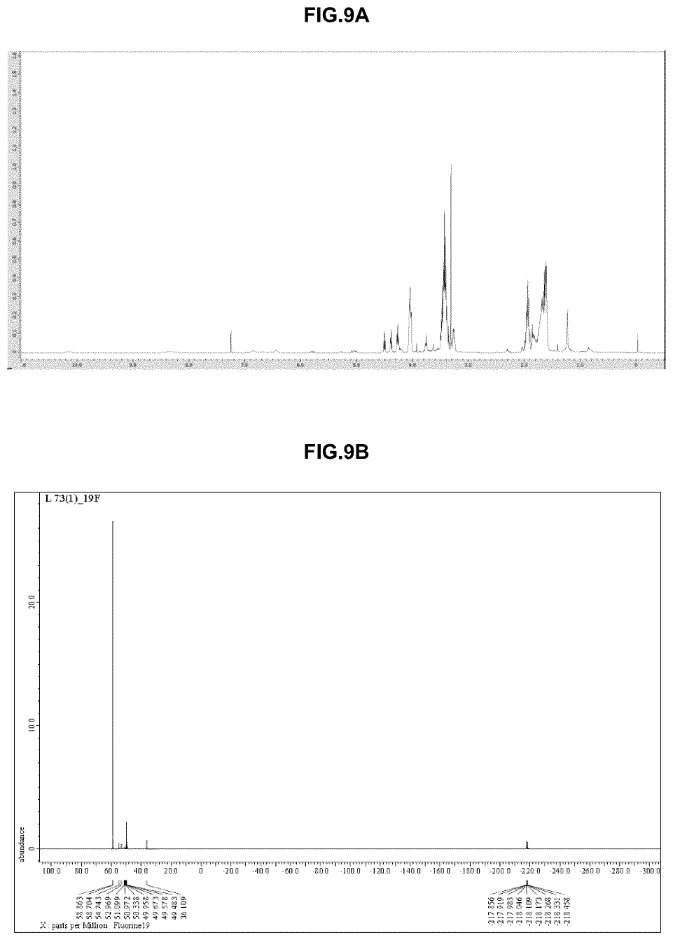

An ionic liquid including a cationic portion represented by the following chemical formula and an FSI anionic portion was prepared (HANIN Co. Ltd.). The ¹H-NMR and ¹⁷F-NMR measurement results for Example 2 are shown in FIGS. 9A and 9B, respectively.

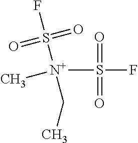

### Example 3

An ionic liquid including a cationic portion represented by the following chemical formula and an FSI anionic portion was designed.

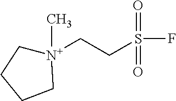

### Comparative Example 1

A conventional ionic liquid ([PYR_{12O1}⁺][FSI⁻]) including PYR_{12O1}⁺ (N-methoxyethyl-N-methylpyrrolidinium) cation and FSI⁻ (fluorosulfonyl imide) anion was purchased (SOLVIONIC).

### Comparative Example 2

DMSF (N,N-dimethylsulfamoyl fluoride) was prepared as a conventional organic solvent (HANIN Co. Ltd.).

### Test Example 1—Measurement of Dark Current of Coin Cell Including Conventional Ionic Liquid

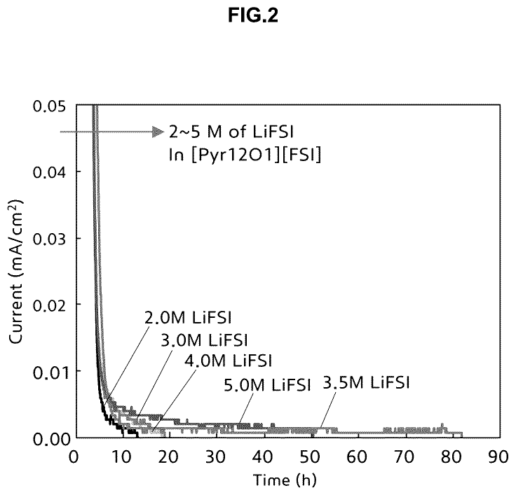

In order to determine whether either of the cationic portion and the anionic portion of a conventional ionic liquid is decomposed, the dark current of the electrolyte prepared by adding LiFSI as a lithium salt to the ionic liquid solvent according to Comparative Example 1 and performing mixing was measured. Specifically, [PYR_{12O1}⁺][FSI⁻] was mixed with LiFSI as a lithium salt at 2 M, 3 M, 4 M, and 5 M and used as electrolytes, and Li/NMC-based coin cells including electrolytes with different concentrations of the lithium salt were manufactured. After repeating 10 charge/discharge cycles, a voltage of 4.3V was applied thereto and current over time was measured. The results thereof are shown in FIG. 2.

Referring to FIG. 2, although the concentration of FSI anions increased with an increase in the concentration of LiFSI from 2 M to 5 M, there was almost no difference in the magnitude of current depending on the concentration over time. Thereby, the film 40 formed on the surface of the anode 20 by charging the lithium secondary battery manufactured using the electrolyte including [PYR_{12O1}⁺][FSI⁻] can be confirmed to be due to decomposition of the cationic portion of [PYR_{12O1}⁺][FSI⁻].

### Test Example 2—Calculation of HOMO and LUMO DFT of Conventional Ionic Liquid

FIGS. 3A and 3B show results of calculation of HOMO (highest occupied molecular orbital) distribution and LUMO (lowest Unoccupied Molecular) distribution using DFT (density functional theory) for the ionic liquid contained in the electrolyte prepared in Test Example 1.

As such, the method of calculating HOMO and LUMO energy levels and orbital distribution using DFT is as follows.

The energy level of a molecular orbital may be determined through quantum chemical calculation. To this end, ‘Materials Studio DMol\hat{ }3 version 2019’ may be used. Specifically, DFT is used, the structure of the molecular ground state is optimized by ‘B3LYP/DNP’ or ‘GGA-PBE/DNP+’, and the single-point energy for the electronic ground state based on the optimized structure is calculated. From energy calculation, the highest occupied molecular orbital (HOMO) may be obtained as the highest energy orbital occupied by, for example, two electrons, and the lowest unoccupied molecular orbital (LUMO) may be obtained as the lowest energy unoccupied orbital. The HOMO/LUMO energy levels may be represented based on the energy level of free electrons in a vacuum level (0 eV). Energy levels may be obtained in a similar way for other molecular orbitals such as HOMO-1, HOMO-2, . . . LUMO+1, LUMO+2, etc.

The method described in the present disclosure is independent of the software package used. Examples of other programs frequently used therefor may be “Gaussian09” (Gaussian Inc.) and Q-Chem 4.1 (Q-Chem, Inc.).

Referring to FIG. 3A, it was confirmed that oxidation mainly occurred in the anionic portion because HOMO was concentrated in FSI anions. Referring to FIG. 3B, it was confirmed that reduction mainly occurred in the cationic portion because LUMO was concentrated in PYR_{12O1}⁺ cations.

As shown in FIGS. 2, 3A, and 3B, it was confirmed that the film 40 formed on the surface of the anode 20 was caused by reductive decomposition of the cationic portion of [PYR_{12O1}⁺][FSI⁻]. This is based on the general understanding that, among cations and anions, cations, which have lower electron density, are more likely to receive electrons than anions.

### Test Example 3—XPS Measurement of Electrolyte Including Conventional Ionic Liquid

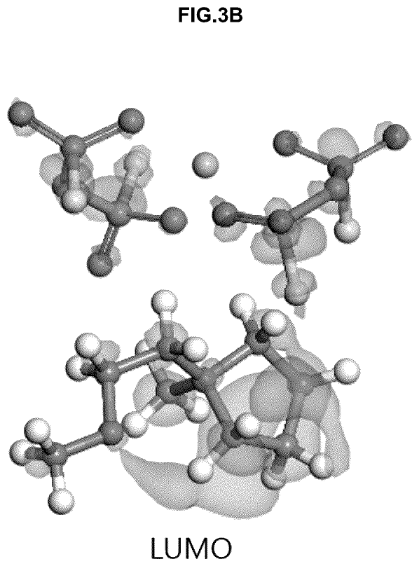

FIG. 4A shows results of O 1s XPS for the electrolyte prepared in Test Example 1, and FIG. 4B shows results of O 1s XPS measured after forming a film 40 on the surface of the anode 20 by exposing the electrolyte including [PYR_{12O1}⁺][FSI⁻] prepared in Test Example 1 to the anode 20 and performing charging.

Referring to FIGS. 4A and 4B, before formation of the film 40, the Li₂O bond was mainly observed and ROLi was hardly observed, whereas after formation of the film 40, the Li₂O peak decreased and the ROLi peak increased. Thereby, it was confirmed that the PYR_{12O1}⁺ cations were decomposed and the film 40 contained LiOCH₃ (ROLi) as a main component.

Therefore, it was confirmed that, when a lithium secondary battery was manufactured using an electrolyte including [PYR_{12O1}⁺][FSI⁻] as a conventional ionic liquid and then charged, a high-resistance film 40 including ROLi was formed.

### Test Example 4—Energy Level Calculation Using DFT

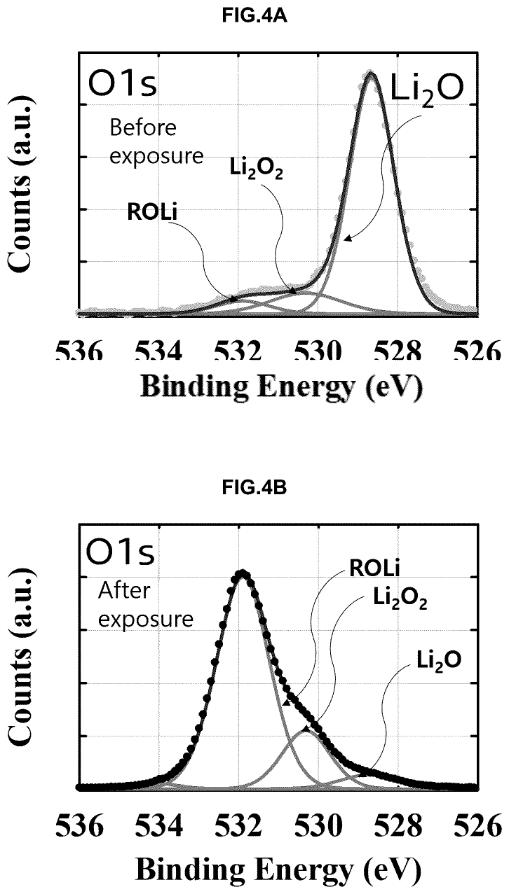

Testing was performed to evaluate the energy levels of the ionic liquids designed or prepared in Examples 1 to 3 and the conventional ionic liquid and DMSF prepared in Comparative Examples 1 and 2. The calculation results using DFT are shown in FIG. 5.

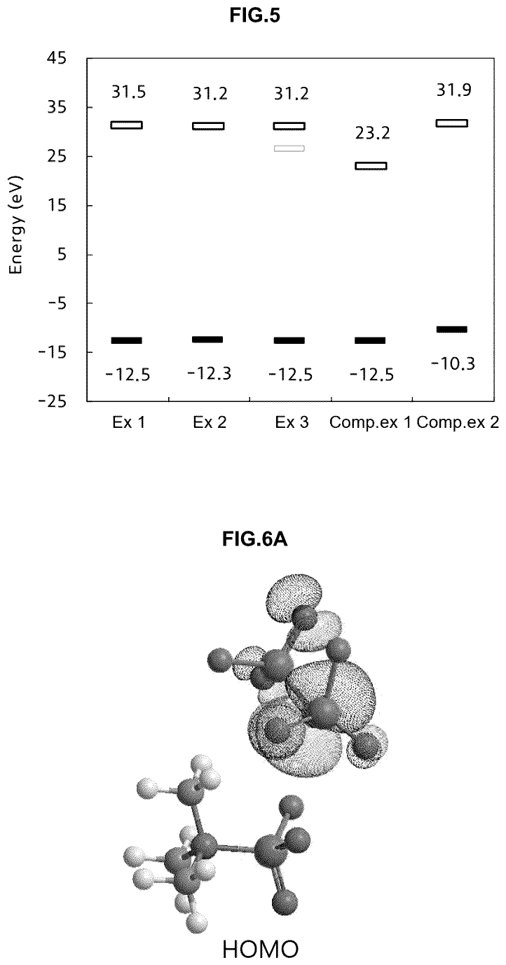

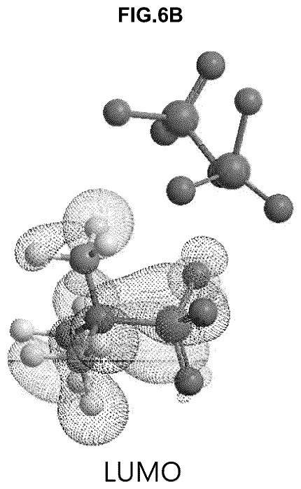

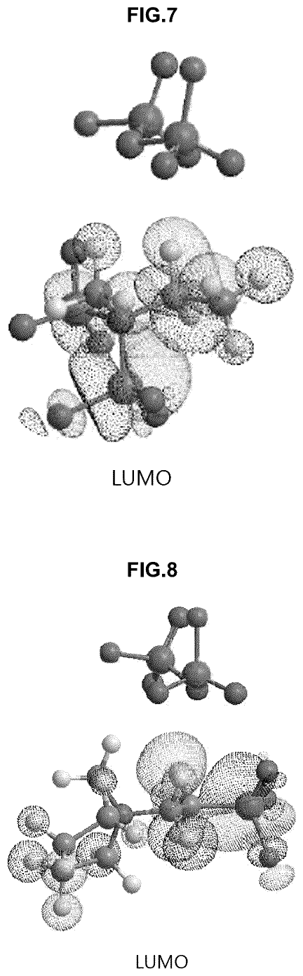

FIGS. 6A and 6B show results of calculation of HOMO distribution and LUMO distribution using DFT for Example 1. FIG. 7 shows results of calculation of LUMO distribution using DFT for Example 2, and FIG. 8 shows results of calculation of LUMO+3 distribution using DFT for Example 3.

Referring to FIG. 5, the HOMO energy level of −12.5 eV and the LUMO energy level of 31.5 eV in Example 1, the HOMO energy level of −12.3 eV and the LUMO energy level of 31.2 eV in Example 2, the HOMO energy level of −12.5 eV and the LUMO+3 energy level of 31.2 eV in in Example 3, the HOMO energy level of −12.5 eV and the LUMO energy level of 23.2 eV in Comparative Example 1, and the HOMO energy level of −10.3 eV and the LUMO energy level of 31.9 eV in Comparative Example 2 were measured.

Based on the above results, the HOMO energy level was lower in the ionic liquids according to Examples 1 to 3 and Comparative Example 1 than the HOMO energy level (−10.3 eV) of Comparative Example 2 using DMSF as the organic solvent. Thereby, it was confirmed that, when using ionic-liquified DMSF as in Examples 1 to 3, oxidative decomposition of the FSI anions due to loss of electrons became difficult, thereby improving oxidation stability.

In addition, in FIG. 6A, the HOMO distribution was concentrated in the FSI anionic portion, indicating that oxidation mainly occurred in anions, and in FIG. 6B, the LUMO distribution was concentrated in the cationic portion, confirming that reduction mainly occurred in cations.

Moreover, in FIG. 5, the LUMO energy levels of Examples 1 and 2 and the LUMO+3 energy level of Example 3 were 31.5 eV, 31.2 eV, and 31.2 eV, respectively, which are similar to the LUMO energy level of 31.9 eV in Comparative Example 2 but are greater than the LUMO energy level of 23.2 eV in Comparative Example 1. Thereby, it can be confirmed that reductive decomposition of the cationic portion of the ionic liquid according to Examples 1 to 3 was delayed compared to the conventional ionic liquid of Comparative Example 1.

Referring to FIGS. 6B, 7, and 8, the LUMO distribution of Examples was concentrated on N—S in the —NSO₂F group. Accordingly, when a film 40 is formed on the surface of the anode 20 by reductive decomposition of the cationic portion, the film 40 thus formed can be predicted to include S⁻ or S²⁻. The film 40 including S⁻ or S²⁻ is known to have higher ionic conductivity than the film 40 including ROLi observed in FIG. 4B.

As is apparent from the above description, according to the present disclosure, an ionic liquid represented by Chemical Formula 1 is capable of forming a film having high ionic conductivity on an anode upon reductive decomposition of the cationic portion of the ionic liquid, and improving oxidation stability by delaying oxidative decomposition of anions.

In particular, an electrolyte including the ionic liquid and a lithium secondary battery including the same include a film formed as a result of charge/discharge cycles on the surface of the anode, and the film includes S⁻, S²⁻, and combinations thereof, thereby suppressing side reactions and growth of dendrites due to coarse lithium intercalation.

The effects of the present disclosure are not limited to the above-mentioned effects. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the invention as disclosed in the accompanying claims, which will also be said to be included within the scope of rights of the present disclosure.

What is claimed is:

1. An ionic liquid for a lithium secondary battery, comprising:
a cation represented by Chemical Formula 1 below; and
an anion: 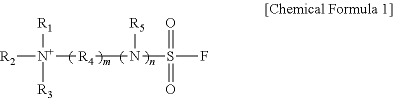
in the Chemical Formula 1, n is 0 or 1, m is 0 or 1,
each of R₁, R₂, R₃ and R₅ is selected from the group consisting of alkyl, cycloalkyl, trifluoromethyl, alkyl ether, cycloalkyl ether, sulfamoyl fluoride, sulfonyl fluoride, alkyl sulfonyl fluoride, halide, alkyl fluoride, cycloalkyl fluoride, alkyl chloride, cycloalkyl chloride, alkyl bromide, and cycloalkyl bromide, and
R₄ is selected from the group consisting of alkyl, cycloalkyl, alkyl ether, and cycloalkyl ether.

2. The ionic liquid of claim 1, wherein two of R₁, R₂, and R₃ are connected to each other to form an alicyclic hydrocarbon ring having 3 to 5 carbon atoms.

3. The ionic liquid of claim 1, wherein the anion comprises at least one selected from the group consisting of N(SO₂F)₂⁻, FSI⁻, CF₃SO₃⁻, N(SO₂CF₃)₂⁻, N(COCF₃)(SO₂CF₃)⁻, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, N(CN)₂⁻, C(CN)₃⁻, SCN⁻, SeCN⁻, CuCl₂⁻, AlCl₄⁻, F(HF)_{2.3}, Cl⁻, F⁻, Br⁻, I⁻, and combinations thereof.

4. The ionic liquid of claim 1, wherein a ratio (LUMO_{II}/LUMO_{DMSF}) of LUMO (lowest unoccupied molecular orbital) energy level of the ionic liquid(LUMO_{IL}) to LUMO energy level of DMSF (N,N-dimethylsulfamoyl fluoride)(LUMO_{DMSF}) is 0.85-1.15.

5. The ionic liquid of claim 1, wherein an absolute value (|LUMO_{IL}−LUMO_{DMSF}|) of a difference between LUMO (lowest unoccupied molecular orbital) energy level of the ionic liquid(LUMO_{IL}) and LUMO energy level of DMSF (N,N-dimethylsulfamoyl fluoride)(LUMO_{DMSF}) is 5 eV or less.

6. The ionic liquid of claim 1, wherein LUMO (lowest unoccupied molecular orbital) energy level of the ionic liquid(LUMO_{IL}) is greater than LUMO energy level of a conventional ionic liquid(LUMO_{COV}).

7. The ionic liquid of claim 6, wherein a ratio (LUMO_{IL}/LUMO_{COV}) of the LUMO energy level of the ionic liquid(LUMO_{IL}) to the LUMO energy level of the conventional ionic liquid(LUMO_{COV}) is 1.4 or less but greater than 1.0.

8. The ionic liquid of claim 1, wherein HOMO (highest occupied molecular orbital) energy level of the ionic liquid(HOMO_{IL}) has a negative value greater than HOMO energy level of DMSF (N,N-dimethylsulfamoyl fluoride)(HOMO_{DMSF}).

9. An electrolyte for a lithium secondary battery, comprising:
the ionic liquid of claim 1; and
a lithium salt.

10. The electrolyte of claim 9, wherein the lithium salt comprises at least one selected from the group consisting of LiFSI, LiTFSI, LiPF₆, LiClO₄, LiBF₄, LiSO₃CF₃, LiBOB, LiFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, and combinations thereof.

11. The electrolyte of claim 9, further comprising an organic solvent.

12. A lithium secondary battery, comprising a cathode; an anode; a separator interposed between the cathode and the anode; and the electrolyte of claim 9 with which at least one of the cathode, the anode, or the separator is impregnated.

13. The lithium secondary battery of claim 12, wherein:
the anode comprises a film located on at least a portion of a surface thereof, and
the film is formed by reductive decomposition of the cation.

14. The lithium secondary battery of claim 13, wherein the film comprises S⁻, S²⁻ or a combination thereof.

15. The lithium secondary battery of claim 13, wherein, based on a result of X-ray photoelectron spectroscopy (XPS) of the film, an S 2p peak appears at a binding energy of 158 eV to 165 eV.
